(19) United States
(12) Patent Application Publication
(10) Pub. No.: US 2014/0169444 A1
(43) Pub. Date: Jun. 19, 2014

(54) IMAGE SEQUENCE ENCODING/DECODING USING MOTION FIELDS

(71) Applicant: MICROSOFT CORPORATION, Redmond, WA (US)

(72) Inventors: Giuseppe Ottaviano, Cambridge (GB); Pushmeet Kohli, Cambridge (GB)

(73) Assignee: MICROSOFT CORPORATION, Redmond, WA (US)

(21) Appl. No.: 13/715,009

(22) Filed: Dec. 14, 2012

(51) Int. Cl. H04N 7/26

(52) U.S. Cl. CPC H04N 19/00
USPC 375/240.01

(57) ABSTRACT

Compressing motion fields is described. In one example video compression may comprise computing a motion field representing the difference between a first image and a second image, the motion field being used to make a prediction of the second image. In various examples of encoding a sequence of video data the first image, motion field and a residual representing the error in the prediction may be encoded rather than the full image sequence. In various examples the motion field may represented by its coefficients in a linear basis, for example a wavelet basis, and an optimization may be carried out to minimize the cost of encoding the motion field and maximize the quality of the reconstructed image while also minimizing the residual error. In various examples the optimized motion field may quantized to enable encoding.

### BACKGROUND

Motion fields, which can be thought of as describing the differences between images in a sequence of images such as video, are often used in the transmission and storage of video or image data. Transmission or storage of video or image data via the internet or other broadcast means is often limited by the amount of bandwidth or storage space available. In many cases data may be compressed to reduce the amount of bandwidth or storage required to transmit or store the data.

The compression may be lossy or lossless. Lossy compression is a method of compressing data that discards some of the information. Many video encoder/decoders (codecs) use lossy compression which may exploit spatial redundancy within individual image frames and/or temporal redundancy between image frames to reduce the bit rate needed to encode the data. In many examples, a substantial amount of data can be discarded before the result is sufficiently degraded to be noticed by the user. However, when the image is reconstructed by the decoder many methods of lossy compression can cause artifacts which are visible to users in the reconstructed image.

Some existing video compression methods may obtain a compact representation by computing a coarse motion field based on patches of pixels known as blocks. A motion vector is associated with each block and is constant within the block. This approximation makes the motion field efficiently encodable, but can lead to the introduction of artifacts in decoded images. In various examples, a de-blocking filter may be used to alleviate artifacts or the blocks can be allowed to overlap, the pixels from different blocks are then averaged on the overlapping area using a smooth window function. Both these solutions reduce block artifacts but introduce blurriness.

In another example, in parts of the image where higher precision is needed, e.g. across object boundaries, each block can be segmented into smaller sub-blocks with segmentation encoded as side information and a different motion vector encoded for each block. However, more refined segmentation requires more bits; therefore, increased network bandwidth is required to transmit the encoded data.

The embodiments described below are not limited to implementations which solve any or all of the disadvantages of known image field encoding and decoding systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Compressing motion fields is described. In one example video compression may comprise computing a motion field representing the difference between a first image and a second image, the motion field being used to make a prediction of the second image. In various examples of encoding a sequence of video data the first image, motion field and a residual representing the error in the prediction may be encoded rather than the full image sequence. In various examples the motion field may represented by its coefficients in a linear basis, for example a wavelet basis, and an optimization may be carried out to minimize the cost of encoding the motion field and maximize the quality of the reconstructed image while also minimizing the residual error. In various examples the optimized motion field may quantized to enable encoding.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of apparatus for encoding video data;

FIG. 2 is a schematic diagram of an example video encoder which utilizes compressible motion fields;

FIG. 3 is a flow diagram of an example method of video encoding which may be implemented by the video encoder of FIG. 2

FIG. 4 is a flow diagram of an example method of obtaining a coding cost of a motion field;

FIG. 5 is a flow diagram of an example method of optimizing an objective function;

FIG. 6 is a flow diagram of an example method of quantization;

FIG. 7 is a schematic diagram of an apparatus for decoding data;

FIG. 8 illustrates an exemplary computing-based device in which embodiments of motion field compression may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a video compression system, the system described is provided as an example and not a limitation. As those skilled in the art will appreciate, the present examples are suitable for application in a variety of different types of image compression systems.

In one example a user may wish to stream data which may be video data, for example for when a user is using an internet telephony service which allows users to carry out video calling. In other examples the streaming video data may be live broadcast video, for example video of a concert, sports event or a current event. In order to stream live video data the image capture, encoding, transmission and decoding of the video data should occur in as near to real-time as possible. Streaming video in real-time can often be challenging due to bandwidth restrictions on networks therefore streaming data may be highly compressed. In an alternative example the video data is not live streaming video data. However, many types of video data may be compressed for storage and/or transmission. For example, a TV on demand service may utilize both streaming and downloading of video data and both require compression. In many examples efficient compression is also needed due to limitations of storage space, for example many people now store large amounts of video data on mobile devices which have limited storage space. However, video encoder/decoders (codecs) which highly compress video data can often lead to the reconstructed decoded images being of a poor quality or having many artifacts. Therefore an efficient encoder which achieves high levels of compression without causing a loss of image quality or introducing artifacts should be used.

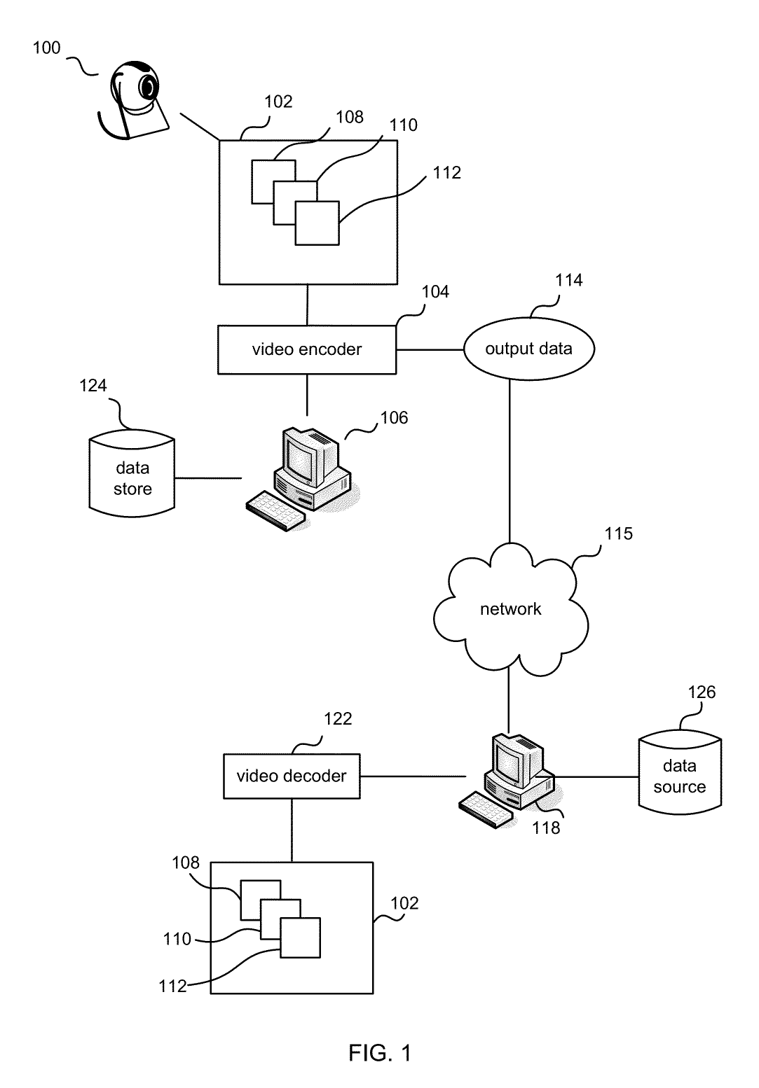

FIG. 1 is a schematic diagram of an example scenario of encoding data for streaming video. In an example an image capture device 100, for example a webcam or other video camera captures images of a user which forms a sequence of video data 102. The video data 102 may be represented by the sequence of still image frames 108, 110, 112. The images may be compressed using a video encoder 104 implemented at a computing device 106. The encoder 104 converts the video data from analogue format to digital format and compresses the data to form compressed output data 114.

The compression carried out by the encoder 104 may, therefore, attempt to minimize the bandwidth requirements for the transmission of the compressed output data 114 while at the same time minimizing the loss of quality.

Video encoder 104 may be a hybrid video encoder that uses previously encoded image frames and side information added by the encoder to estimate a prediction for the current frame. The side information may be a motion field. In an example, a motion field compensates for the motion of the camera and motion of objects in a scene across neighboring frames by encoding a vector which indicates the difference in position of an object e.g. a pixel between frames. The output data 116 of the encoder may be encoded data representing a reference frame from the sequence of images, the motion field which may be a computed difference between the reference image and another image in the sequence of images and a residual error, the residual error may be an indication of the difference between the prediction for the encoded image given by warping the reference image with the motion field and the image itself.

In an example, if a person, e.g. the user, moves their head to the left between a first frame and a second frame then the motion field may encode this difference. In another example, if the camera was tracking between frames, e.g. tracking left to right, then the motion field may encode the movement between frames. A dense motion field may be a field of per-pixel motion vectors which describes how to warp the pixels in the previously decoded frame to from a new image. By warping the previously encoded image with the motion field a prediction for the current image may be obtained. The difference between the prediction and the current frame is known as the residual or prediction error and is separately encoded to correct the prediction.

The computing device 106 may transmit output data 114 from the encoder via a network 116 to a remote device 118, for display on a display of the remote device. Computing device 104 and remote device 118 may be any appropriate device e.g. a personal computer, server or mobile computing device, for example a tablet, mobile telephone or smart-phone. Network 116 may be a wired or wireless transmission network e.g. WiFi, Bluetooth™, cable, or other appropriate network.

In another example output data 114 may alternatively be written to a computer readable storage media, for example a data store 124, 126 at computing device 104 or remote device 118. Writing the output data to a computer readable storage media may be carried out as an alternative to, or in addition to displaying the video data in real time.

The compressed output data 114 may be decoded using video decoder 122. In an example video decoder 122 is implemented at remote device 118, however it may be located on the same device as video encoder 104 or a third device. As noted above, the output data may be decoded in real-time. The decoder 122 may restore each image frame 108, 110, 112 of the video data sequence 102 for playback.

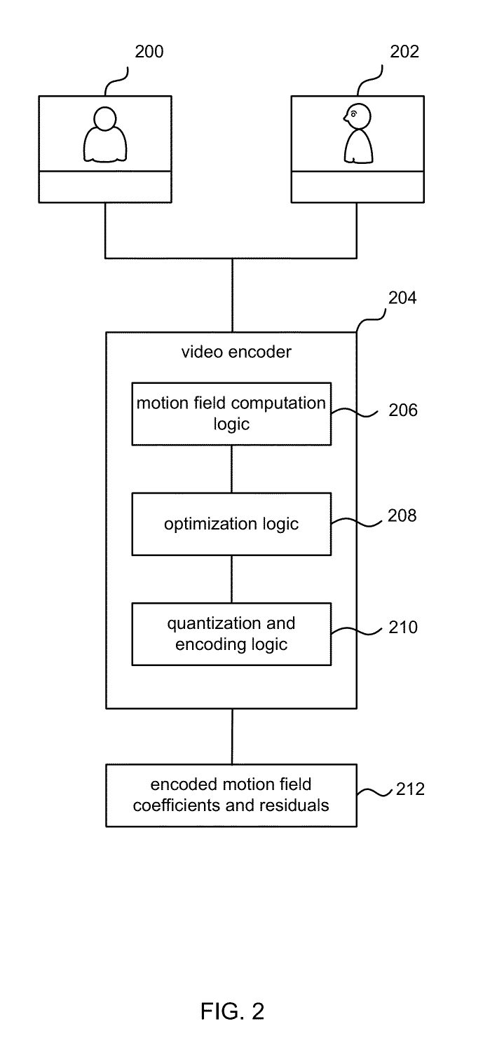

FIG. 2 is a schematic diagram of an example video encoder which utilizes compressible motion fields. Images, for example images I₁ 200 and I₀ 202, which form part of a video data sequence may be received at video encoder 204. In the first image 200 a user may be face on to the camera, in the second image 202 the user may have turned their head to the left; therefore a motion field may be used to encode the difference between the two frames.

Video encoder 204 may comprise motion field computation logic 206. Motion field computation logic 206 computes a motion field and a residual from pairs of still image frames, for example, images I₁200 and I₀202. In an embodiment the motion field may be represented by a plurality of coefficients, wherein the coefficients are numerical values computed using a family of mathematical functions. The family of mathematical functions selected to compute the coefficients are known as the basis.

The motion field may not be an estimate of the true motion of the scene, in an ideal example, each pixel in the image would be associated to a motion vector that minimizes the residual. However such a motion field may contain more information than the image itself, therefore some freedom in computing the field must be traded for efficient encoding of the residual. In examples a motion field is computed that does not describe the motion exactly but can be compressed and also leads to a small residual. In an example, the video encoder may utilize dense compressible motion fields which may be optimized for both compressibility and residual magnitude.

In many video compression algorithms the largest transmission cost is in encoding the prediction for I₀202 derived from warping images I₁200 with the motion field rather than in encoding the residual error. Optimization logic 208 may be arranged to optimize the residual error subject to a cost of encoding the motion field. The budget for encoding the motion field may be specified a-priori or determined at runtime. In an example the optimization may comprise trading off a bit cost of encoding the motion field with residual magnitude. Therefore the efficiency of the video encoding may be optimized subject to the constraints of quality and coding cost.

Quantization and encoding logic 210 may be arranged to encode the optimized motion field u into a minimal number of bits without degrading the quality of the residual. In an embodiment, quantization and encoding logic 210 may be arranged to encode the solution to u by dividing the coefficients of the motion field into blocks and assigning a quantizer to each block. In an example the quantizer is a uniform quantizer q. The outputs 212 of video encoder 204 are, therefore, encoded motion field coefficients and residuals.

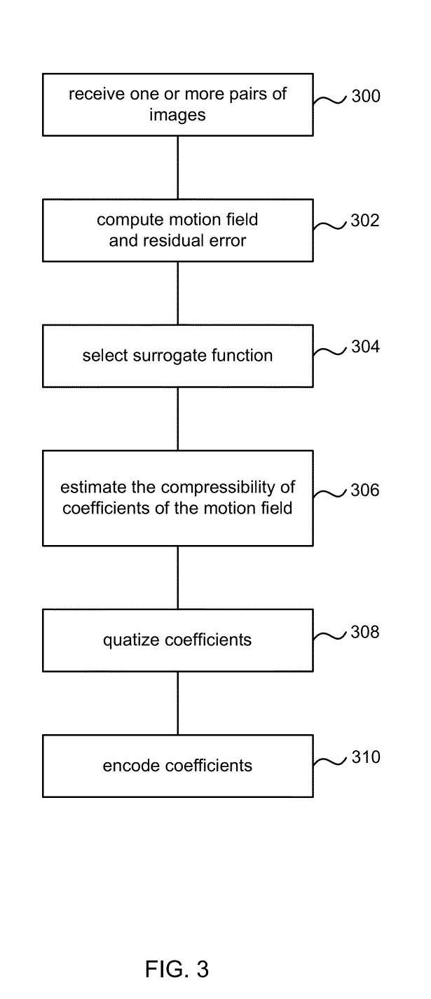

FIG. 3 is a flow diagram of an example method of video encoding which may be implemented by the encoder of FIG. 2. In an embodiment one or more pairs of images 200, 202 are received 300 at an example video encoder 204. For example the images may be images from a webcam which is recording video data of a user.

For a pair of images selected from image frames in a video sequence, for example image pair I₁200 and I₀202, a motion field u and a residual error can be computed 302 by motion field logic 206 as a field of per-pixel motion vectors describing how to warp the pixels from I₁200 to form a new image I₁(u). In an embodiment motion field u is a dense motion field. The new image I₁(u) may be used as a prediction for I₀202. The motion field may not be an estimate of the true motion of the scene, in an ideal example, each pixel in the image would be associated to a motion vector that minimizes the residual. However, such a motion field may contain more information than the image itself, therefore some freedom in computing the field may be traded for efficient encodability.

In an embodiment motion field u may be represented by a plurality of coefficients in a given basis, where a basis is a family of mathematical functions. In an embodiment the basis may be a linear wavelet basis. A linear wavelet basis is a family of “wave like” mathematical functions which can be added linearly to represent a continuous function. In an example the linear wavelet basis may be represented by a matrix W. In various examples, the basis may be selected to represent sparsely a wide variety of motions and to allow efficient optimizations. In an embodiment the linear wavelet basis may be orthogonal wavelets, for example a sequence of square shaped functions such as Haar or least asymmetric wavelets.

In an example a surrogate function may be selected 304 to enable estimation of the compressibility of the coefficients of the motion field. In an example, selecting the surrogate function may comprise searching a plurality of surrogate functions to find the surrogate function which optimizes the compressibility of the motion field. In an example the selection of the surrogate function may be carried out in advance using a set of training data. In another example the selection of the surrogate function may be carried out at runtime for each computed motion field. In an example the surrogate function is a tractable surrogate function; that is, one which may be computed in a practical manner.

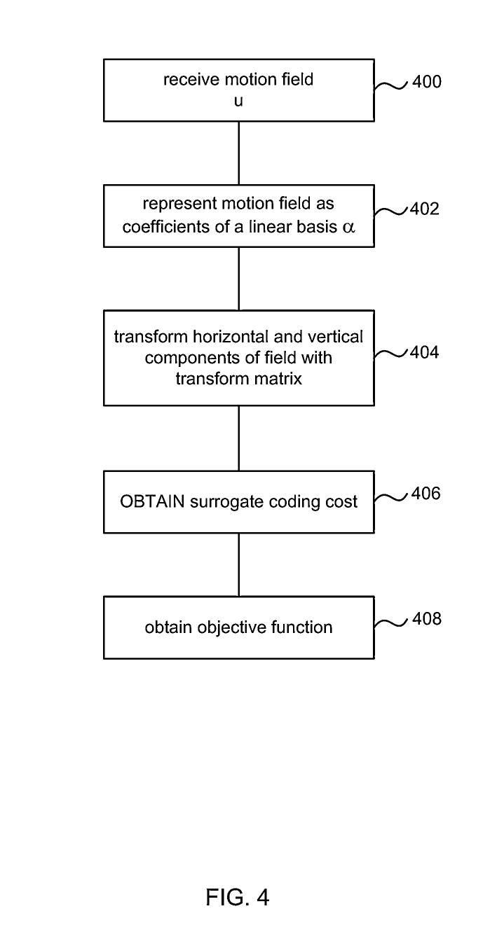

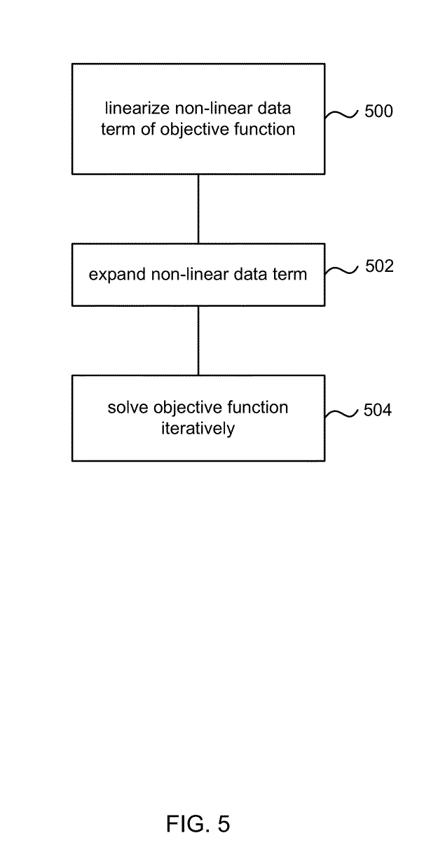

In an embodiment the compressibility of coefficients of the motion field is estimated 306 by optimizing over an objective function which reduces the residual error subject to the surrogate function. For example, the objective function may be optimized for both residual size and compression of the field. For example the residual may be minimized with respect to a surrogate function for the bit cost (also referred to as space cost) of coding the motion field. Selection of a surrogate function is described in more detail with reference to FIG. 4 below and estimation of the compressibility of coefficients of the motion field through optimization is described below with reference to FIG. 5. In an example the surrogate function is a piecewise smooth surrogate function.

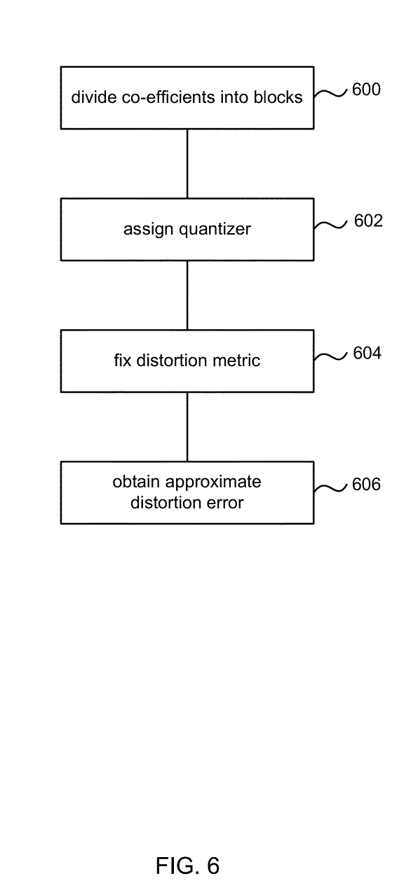

The optimized motion field coefficients in the selected basis may then be quantized 308 and encoded 310. More detail with regard to the quantization of the motion field is given below with reference to FIG. 6. The quantized coefficients can then be encoded for transmission or storage.

FIG. 4 is a flow diagram of an example method of obtaining a coding cost (also referred to as a space cost) of a motion field. In an embodiment a single component of a greyscale image may be represented as a vector in a set of real numbers [symbol] ^{w×h} where w is the width and h is the height. In an embodiment a motion field u is received 400 at optimization logic 208. The motion field u may be represented as a vector in [symbol] ^{2×w×h} with u₀ being the horizontal component of the motion field and u₁ the vertical component of the motion field.

The motion field may be constrained to vectors inside the image rectangle i.e. 0≦i+u_{0,i,j}≦w-1 and 0≦j+u_{1,i,j}≦h-1 for every 0≦i≦w-1 and 0≦j≦h-1. This is known as the set of feasible fields [symbol] . The motion field u can be represented 402 as coefficients α of a linear basis represented by a matrix W, so that u=Wα and α=W⁻¹u. In various examples the linear basis may be a wavelet basis.

In an embodiment Bits(W⁻¹u) may be used to denote the coding cost of u i.e. the number of bits obtained by quantizing and coding the coefficients of W⁻¹u with an encoder and the residual may be represented by I₀−I₁(u), the difference between the prediction for current frame and the frame. Given a bit budget B for the field the residual can be minimized subject to the budget

[symbol]

∥I₀−I₁(u)∥s.t. bits(W⁻¹u)≦B (1)

where ∥·∥ is some distortion measure. As noted above, the budget may be specified in advance or at runtime. In an example the distortion measure may be an L¹or an L² norm, which are a way of describing the length, distance or extent of a vector in a finite space. However, generalizations to other norms may be used. Equation 2 trades off the residual error subject to the cost of encoding the motion field coefficients to determine whether, given a limited number of bits for encoding B whether it is best to have a large residual error or spend a significant amount of bits encoding the motion field.

In an example rate distortion optimization may be used to optimize the coding cost. Rate distortion optimization refers to the optimization of the loss of video quality against the amount of data required to encode the video data. In an example rate distortion optimization solves the aforementioned problem by acting as a video quality metric, measuring both the deviation from the source material and the bit cost for each possible decision outcome. The bits are mathematically measured by multiplying the bit cost by the Lagrangian λ, a value representing the relationship between bit cost and quality for a particular quality level.

Using a rate distortion approach the above equation (1) can be re-written as

[symbol]

∥I₀−I₁(u)∥+λ bits(W⁻¹u) (2)

Where λ is the Lagrangian multiplier which trades off bits of the field encoding for residual magnitude. In one example this parameter can be set a priori, e.g. by estimating it from the desired bit rate. In another example this parameter can be optimized.

In order to optimize the above equation it is necessary to obtain 406 a tractable surrogate function. In an embodiment, the encoder may search over a plurality of surrogate functions. The surrogate function may be selected according to one or more parameters. In an embodiment the surrogate function selected may be the surrogate function which optimizes the bit cost of encoding the motion field of a sample or training data set at training time. In other examples the surrogate function may be selected frame by frame or data set by data set, to achieve an optimum bit cost for the frame or data set.

In an embodiment the received 400 motion field may be represented as a wavelet field. W is assumed to be a block-diagonal matrix with diag(W′, W′) i.e. the horizontal and vertical components of the field are transformed 404 independently with the same transform matrix. W′ may be an orthogonal separable multilevel wavelet transform i.e. W⁻¹=W^{T}. The wavelet transform may use any appropriate wavelets, for example, Haar wavelets or least-asymmetric (Symlet) wavelets. In an example the coefficients α=W^{T}u can be divided into levels which represent the detail at each level of a recursive wavelength decomposition. In an example, in a separable 2D case each level (except the first) can be further divided into 3 sub-bands which correspond to the horizontal, vertical and diagonal detail. In a specific example 6 levels (5 plus an approximation level) may be used. However, any appropriate number of levels may be used, for example more or less than 6 levels, The b-th sub-band may be denoted as (W^{T}u)_{b}, so that the i-th coefficient of the b-th sub-band is (W^{T}u)_{b,i}.

Encoding the coefficients of W^{T}u comprises encoding the positions of the non-zero coefficients and the sign and magnitude of quantized coefficients. In an example ū is a solution of equation (2) with integer coefficients in a transformed basis, n_{b} is the number of coefficients in the sub-band b and m_{b}the number of non-zeros. In an example the entropy of the set of positions of the non-zeros in a given sub-band can be upper bounded by

$${m}_{b} ( 2 + log ( \frac{{n}_{b}}{{m}_{b}} ) ) .$$

The contribution of each coefficient ā_{b,i}=(W^{T}ū)_{b,i} can be written as (log n_{b}−log m_{b}+2)II[α_{b,i}≠0]. Optimizing over the sparsity of the vector may be a hard combinatorial problem therefore approximations can be made to enable optimization of the motion field coefficients.

In an example, it can be assumed that if the solution is sparse m_{b} can be fixed to a small constant. In another example it can be assumed that the indicator function II[α_{b,i}≠0] with log(|α_{b,i}|+1) where it is assumed that the number of bits needed to encode a coefficient α can be bounded by γ₁ log |α+1|+γ₂. Combining these two approximate costs the per-coefficient surrogate bit cost may be approximated by (log n_{b}+c_{b,1})log(|α_{b,i}|+1)+c_{b,2}, with c_{b,1} and c_{b,2} constants. Writing β_{b}=log n_{b}+c_{b,1} and ignoring c_{b,2} a surrogate coding cost function may be obtained 406

∥W^{T}u∥_{log,β}=Σ_{b}β_{b}Σᵢ log(|(W^{T}u)_{b,i}|+1) (3)

By substituting equation (3) into equation (2) an objective function may be obtained 408:

[symbol]

∥I₀−I₁(u)∥₁+λ∥W^{T}u∥_{log,β} (4)

In the example shown, the objective function comprises, in words, a first term representing the residual error and a second term representing the surrogate function for the cost of encoding plurality of coefficients of the motion field in a given wavelet basis multiplied by a Lagrangian multiplier trades off bits of the field encoding for residual magnitude.

Concave penalties may be used to encourage sparse solutions. In the example shown above, a weighted logarithmic penalty on the transformed coefficients is used as a regularization term to encourage sparse solutions. In an embodiment the motion fields obtained may have very few non-zero coefficients.

In an example additional sparsity can be reinforced by controlling the parameters β_{b}, for example, β_{b} can be set to ∞ to constrain the b-th sub-band to be zero. In an embodiment this may be used to obtain a locally constant motion field by discarding the higher-resolution sub-bands. In a specific example the weights β_{b} can be increased by 2 per level, however, any appropriate weighting may be used.

FIG. 5 is a flow diagram of an example method of optimizing an objective function, for example the objective function given by equation (4) above. The non-linear data term ∥I₀−I₁(u)∥₁ of the objective function may be linearized 500. An expansion 502 of the non-linear data term may then be performed. In an embodiment, given a field estimate u₀ a first order Taylor expansion of I₁(u) at u₀ can be performed, giving a linearized data term ∥I₀−(I₁(u₀)+∇I₁[u₀](u−u₀))∥₁ where ∇I₁[u₀] is the image gradient of I₁ evaluated at u₀. The term may be written as ∥∇I₁[u₀]u−ρ∥₁ with ρ a constant term. The linearized objective is therefore:

∥∇I₁[u₀]u−ρ∥₁+λ∥W^{T}u∥_{log,β} (5)

Equation (5) is a complex problem which is difficult to minimize. However, the two terms may be handled individually. In an example, an auxiliary variable v and a quadratic coupling term that keeps u and v close may be introduced:

$${‖ ∇ {I}_{1} [ {u}_{o} ] v - ρ ‖}_{1} + \frac{1}{2 θ} {‖ v - u ‖}_{2}^{2} + λ {‖ {W}^{T} u ‖}_{log , β} \qquad ( 6 )$$

The objective function can, therefore, be solved iteratively 504. In an example, u or v are held fixed in alternate iteration steps. The linearization may be refined at each iteration and the coupling parameter θ allowed to decrease. θ may decrease exponentially, for example. An estimate of the optimization may be projected to [symbol] ∩[−1,1]^{2×n} to constrain the estimate to be feasible.

In an example, in an iteration where u is kept fixed,

$${‖ ∇ {I}_{1} [ {u}_{o} ] v - ρ ‖}_{1} + \frac{1}{2 θ} {‖ v - u ‖}_{2}^{2}$$

can be optimized over v pixel-wise by soft-thresholding of the entries of the field.

In an example, in an iteration where v is kept fixed,

$$\frac{1}{2 θ} {‖ v - u ‖}_{2}^{2} + λ {‖ {W}^{T} u ‖}_{log , β}$$

can be optimized over u by changing the variable z=W^{T}u so that the function becomes

$$\frac{1}{2 θ} {‖ {W}^{T} v - z ‖}_{2}^{2} + λ {‖ z ‖}_{log , β} .$$

Since W is orthogonal, this is equal to

$$\frac{1}{2 θ} {‖ {W}^{T} v - z ‖}_{2}^{2} + λ {‖ z ‖}_{log , β} .$$

The function is now separable and may therefore be reduced to component-wise optimization of the one dimensional problem (x−y)²+t log(|x|+1) in x for a fixed y. The minimum is therefore 0 or

$$\frac{1}{2} sgn ( y ) ( y - 1 + \sqrt{{( y + 1 )}^{2} - 4 t} )$$

where the latter exists, so both points can be evaluated to find the global minimum.

In an embodiment the surrogate bit cost ∥W^{T}u∥_{log,β} may closely approximate the actual bit cost. For example, the correlation between estimated cost and actual number of bits may be in excess of 0.96.

FIG. 6 is a flow diagram of an example method of quantization. In an embodiment the solution to the objective function e.g. the objective function of equation (4) is real valued. The solution may be encoded into a finite number of bits. In an embodiment the coefficients may be divided 600 into blocks. In an example the blocks are small square blocks.

A quantizer may then be assigned 602 to each block. In an example, a quantizer is a uniform dead-zone quantizer therefore if a coefficient α is located in block k the integer value sign

$$( α ) [ \frac{α}{{q}_{k}} ]$$

is encoded. However, any appropriate quantizer may be used.

A distortion metric may then be fixed 604 on the coefficients to be encoded. In one example a component-wise distortion metric D may be used, for example, a squared difference distortion metric and the objective:

$${min}_{q} {\sum }_{i} D ( {α}_{i} {\tilde{α}}_{i , q} ) + {λ}_{quant} bits ( {\tilde{α}}_{i , q} )$$

is optimized over q=(q₁, . . . , qₖ, . . . ) where \tilde{α}_{i,q} is the quantized value of \tilde{α}ᵢ under the choice of quantizers q and λ_{quant} is again a Lagrangian multiplier that trades off distortion for bitrate. If the search space is discrete and exponentially large in the number of blocks, each block can be optimized separately so the running time is linear in the number of blocks and quantizer choices.

One example of a distortion metric D is a squared difference D (x, y)=(x−y)²; if α=W^{T}u is the vector of coefficients, the total distortion is equal to ∥α−\tilde{α}_{q}∥₂²; by orthogonality of W this is equal to ∥u−ũ_{q}∥₂² where ũ_{q}=Wã_{q} hence equal to the squared distortion of the field. By setting a strict bound on the average distortion, the quantized field can be made close to the real valued field. An example bound is less than quarter pixel precision. However, not all motion vectors require the same precision, in smooth areas of the image an imprecise motion vector may not induce a large error in the residual while around sharp edges the vectors should be as precise as possible.

Therefore in an example the precision of the vectors may be related in some way to the image gradient. In an example a distortion metric may be related to a warping error ∥I(u)−I(ũ)∥ for some norm ∥·∥. However the distortion metric may be non-separable as a function of the transformed coefficients, Therefore the distortion error may be approximated by deriving a coefficient-wise surrogate distortion metric that approximates 608 the distortion error.

In an example, the warping error around u may be linearized to obtain ∥∇I[u](u−ũ_{q})∥. In embodiments where the quantization error is small, linearization is a suitable approximation. Exploiting the linearity, the warping error can be rewritten as ∥∇I[u]W(α−\tilde{α}_{q})∥=∥∇I[u]W\tilde{e}∥, where \tilde{e}=α−\tilde{α}_{q} is the quantization error. The argument of the norm is now linear in \tilde{α}_{q}, however, the operator W introduces high-order dependencies between the coefficients which means that this function cannot be used as a coefficient-wise distortion metric.

In an example the distortion ∥·∥ is L² and if a diagonal matrix Σ=diag(σ₁, . . . , σ₂ₙ) such that ∥Σ\tilde{e}∥₂ approximates ∥∇I[u]W \tilde{e}∥₂ then a distortion metric D_{Σ}(αᵢ, \tilde{α}ᵢ)²=σᵢ²(αᵢ−\tilde{α}ᵢ)² may be used in the objective function and an approximation to the square linearized warping error may be obtained 608.

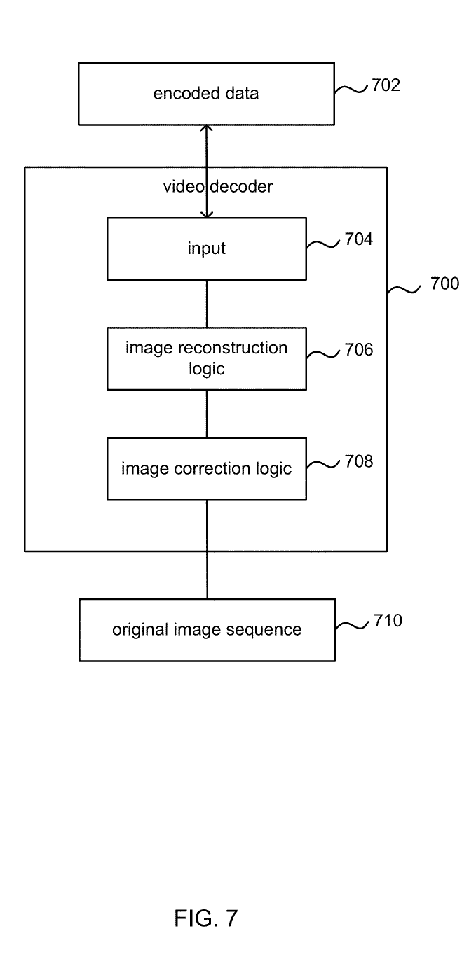

FIG. 7 is a schematic diagram of an apparatus for decoding data. The apparatus may comprise video decoder 700 which may be implemented in conjunction with video encoder 200 or may be implemented separately, for example, video encoder 200 and video decoder 700 may be implemented in software as a video codec. In another example the video decoder may be implemented on a remote device, for example a mobile device, without the video encoder.

The video decoder may comprise an input 704 arranged to receive encoded data 702 comprising one or more reference images, motion fields and residual errors. In an example the coefficients of the motion field and residual error may be determined by optimizing an objective function which minimizes the residual error subject to the surrogate function for the cost of encoding the plurality of coefficients as described with reference to FIG. 2 and FIG. 3 above.

The video decoder may also comprise image reconstruction logic 706 arranged to reconstruct an image frame in an image sequence by warping the reference frame with the motion field to obtain an image prediction and image correction logic 708 arranged to correct the image prediction using information contained in the residual error to obtain the original input image from the image sequence 710. Output original image sequence 710 may be displayed on a display device during playback of an image sequence by a user.

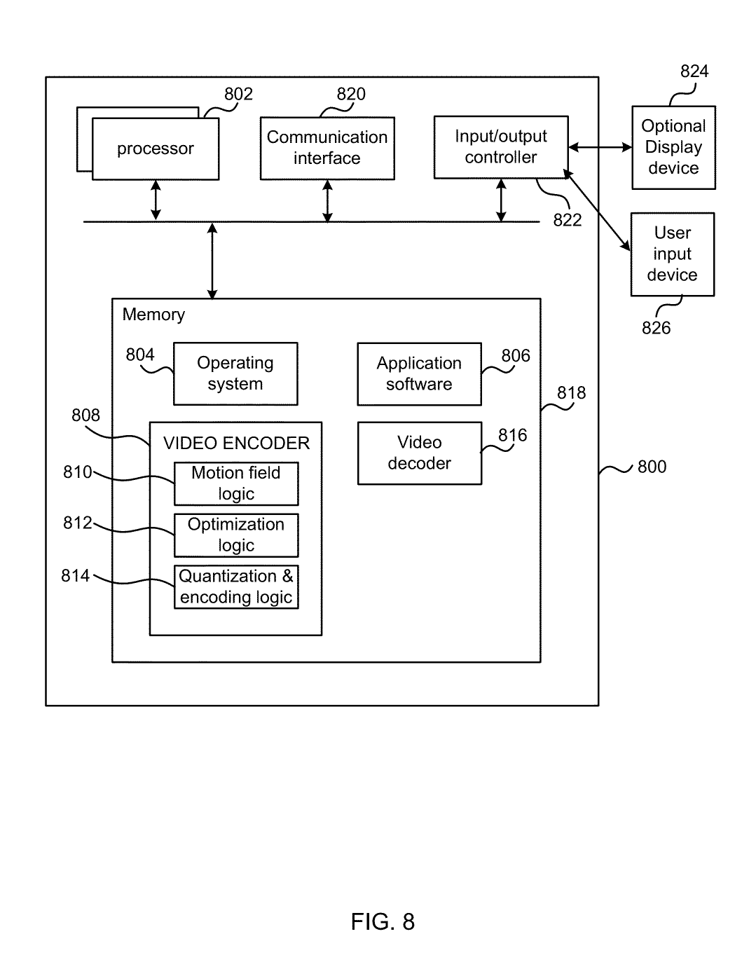

FIG. 8 illustrates various components of an exemplary computing-based device 800 which may be implemented as any form of a computing and/or electronic device, and in which embodiments of video encoding and decoding may be implemented.

Computing-based device 800 comprises one or more processors 802 which may be microprocessors, controllers or any other suitable type of processors for processing computer executable instructions to control the operation of the device in order to generate motion fields from image data and encode the motion field and residual data. In some examples, for example where a system on a chip architecture is used, the processors 802 may include one or more fixed function blocks (also referred to as accelerators) which implement a part of the method of data compression in hardware (rather than software or firmware). Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

Platform software comprising an operating system 804 or any other suitable platform software may be provided at the computing-based device to enable application software 806 to be executed on the device. A video encoder 808 may also be implemented as software at the device. Video encoder 808 may comprise one or more of motion field logic 810, optimization logic 812 and quantization and encoding logic 814. Alternatively or additionally a video decoder 816 may be implemented. In an example video encoder 808 and/or decoder 816 are implemented as application software, which may be in the form a video codec.

The computer executable instructions may be provided using any computer-readable media that is accessible by computing based device 800. Computer-readable media may include, for example, computer storage media such as memory 818 and communications media. Computer storage media, such as memory 818, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 818) is shown within the computing-based device 800 it will be appreciated that the storage may be distributed or located remotely and accessed via a network or other communication link (e.g. using communication interface 820).

The computing-based device 800 also comprises an input/output controller 822 arranged to output display information to a display device 824 which may be separate from or integral to the computing-based device 800. The display information may provide a graphical user interface. The input/output controller 822 is also arranged to receive and process input from one or more devices, such as a user input device 826 (e.g. a mouse, keyboard, camera, microphone or other sensor). In some examples the user input device 826 may detect voice input, user gestures or other user actions and may provide a natural user interface (NUI). This user input may be used to generate video data and/or motion field data. In an embodiment the display device 824 may also act as the user input device 824 if it is a touch sensitive display device. The input/output controller 822 may also output data to devices other than the display device, e.g. a locally connected printing device (not shown in FIG. 8).

The input/output controller 822, display device 824 and optionally the user input device 826 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of encoding an image sequence by computing and encoding a motion field and a residual error for a pair of image frames selected from the image sequence;
selecting a representation for the motion field and computing the motion field in the selected representation by trading off a space cost of encoding the motion field in the representation against a space cost of encoding the residual error.

2. A method according to claim 1 wherein trading off comprises optimizing an objective function having a first term representing a space cost of encoding the residual error and a second term representing a surrogate function which mimics a space cost of encoding the motion field.

3. A method according to claim 1 wherein the representation for the motion field is a wavelet representation.

4. A method according to claim 2 wherein optimizing the objective function comprises iteratively linearizing the residual term to find a global minimum.

5. A method according to claim 1 further comprising computing the motion field as a plurality of coefficients of a wavelet basis.

6. A method according to claim 5 comprising quantizing the motion field by dividing the plurality of coefficients into blocks and assigning a quantizer to each block.

7. A method according to claim 6 wherein the quantizer is a uniform dead-zone quantizer.

8. A method to claim 6 further comprising using a distortion metric to obtain an approximation of a warping error introduced by the quantizer.

9. A method as claimed in claim 1 at least partially carried out using hardware logic.

10. A method of image sequence encoding comprising;
computing a motion field and a residual error from a pair of image frames selected from image frames in an image sequence;
selecting a surrogate function for a cost of encoding the motion field in a given linear wavelet basis; and
calculating the motion field by optimizing over an objective function which minimizes the residual error subject to the surrogate function for the cost of encoding the motion field.

11. A method according to claim 10 wherein the wavelet basis is an orthogonal wavelet basis.

12. A method according to claim 10 wherein the basis is selected to represent sparsely a wide variety of motions.

13. A method according to claim 11 wherein the orthogonal wavelets are select from one of Haar wavelets or least-asymmetric wavelets.

14. A method according to claim 10 wherein selecting a surrogate function comprises searching a plurality of parameters to find parameters of the surrogate function which minimizes the cost of encoding the motion field.

15. A method according to claim 14 wherein searching the plurality of surrogate functions comprises;
for each surrogate function estimating the compressibility of the motion field by optimizing over an objective function which minimizes the residual error subject to the surrogate function for the cost of encoding the plurality of coefficients.

16. A method according to claim 10 wherein the surrogate function is a piecewise smooth function.

17. A method according to claim 14 wherein the selection of the surrogate function is carried out using a set of training data.

18. A method according to claim 14 wherein the selection of the surrogate function is at runtime for each motion field computed by the video encoder.

19. An image sequence decoder comprising:
an input arranged to receive encoded data comprising one or more reference images, motion fields and residual errors, wherein the motion field is in the form of coefficients of a wavelet basis;
image reconstruction logic arranged to reconstruct an image frame in an image sequence by warping the reference frame with the motion field to obtain an image prediction; and
image correction logic arranged to correct the image prediction using information contained in the residual error to obtain the original input image sequence.

20. A decoder as claimed in claim 19 wherein the coefficients of the motion field and the residual error have been computed by optimizing an objective function which minimizes the residual error subject to a surrogate function for the cost of encoding the motion field coefficients.
